(19) United States
(12) Patent Application Publication
(10) Pub. No.: US 2009/0200931 A1
(43) Pub. Date: Aug. 13, 2009

(54) ORGANIC EL DEVICE AND METHOD OF MANUFACTURING THE SAME

(75) Inventors: Shuichi TAKEI, Shimasuwa-machi (JP); Atsushi KITABAYASHI, Chino-city (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/359,765

(22) Filed: Jan. 26, 2009

(30) Foreign Application Priority Data
Feb. 8, 2008 (JP) 2008-029339

(51) Int. Cl. H01J 1/63; B05D 5/12

(52) U.S. Cl. 313/504; 427/66

(57) ABSTRACT

An organic EL device includes a substrate, an organic planarizing layer disposed on the substrate, a first electrode disposed on the organic planarizing layer, a partition wall disposed on the first electrode and having an opening which defines the first electrode and exposes an upper portion of the first electrode, a functional layer disposed in the opening of the partition wall, and a second electrode disposed so as to cover the functional layer. The partition wall includes at least an inorganic partition wall portion, and the inorganic partition wall portion has an inorganic partition wall portion through-hole which passes through the inorganic partition wall portion and extends to the organic planarizing layer.

### BACKGROUND

1. Technical Field

The present invention relates to an organic EL device and a method of manufacturing the same.

2. Related Art

Organic EL devices, each having many organic EL (electroluminescence) elements disposed on a substrate, are known. In general, an organic EL element includes a planarizing layer which covers thin-film transistors (TFTs), lines, etc. disposed on a substrate, an electrode (anode) disposed on the planarizing layer, a partition wall having an opening which defines the electrode, a functional layer disposed in the opening of the partition wall, and an electrode (cathode) which is disposed so as to cover the functional layer. In particular, when a functional layer, such as an organic luminescent layer, is formed using a liquid-phase material, after the liquid-phase material of the functional layer is arranged in the opening of the partition wall, drying is performed.

An organic EL device has been disclosed in which, when thin films having different properties are formed by patterning on the same substrate, liquid thin film materials are prevented from overflowing beyond banks, and flat thin-film layers with uniform thickness having stable properties without color irregularities or the like can be formed reliably, with high precision, relatively easily, and with high yield, thus allowing high-definition micropatterning (for example, refer to Japanese Patent No. 3,328,297). Furthermore, an organic EL device has been disclosed which is capable of realizing uniform light emission by decreasing the voltage drop when current flows in the horizontal direction and in which, even if active elements, such as TFTs, are used, the aperture ratio and light transmittance are not decreased (for example, refer to JP-A-2003-123988).

However, in the process of manufacturing the existing organic EL elements, an organic planarizing layer composed of an organic material is exposed to processing liquids, such as a resist stripper used in photolithography. Furthermore, the organic planarizing layer contains a large amount of impurities that generate gases, such as a solvent remaining inside. Consequently, substances contained in the processing liquids may act on the impurities in the organic planarizing layer to thereby generate gases. Such gases are also generated after a highly airtight layer, such as an anode composed of an inorganic material or the like, or an inorganic partition wall portion, is formed on the organic planarizing layer. Consequently, the generated gases may accumulate without being discharged to outside the organic EL device, resulting in the occurrence of dark spots, which degrade the display quality. Such dark spots grow with time even after the organic EL device has been fabricated, and a region including a plurality of pixels may become a non-light-emitting region.

### SUMMARY

An advantage of some aspects of the invention is that it provides an organic EL device capable of preventing the display quality from being degraded by gases generated from an organic planarizing layer, and a method of manufacturing the organic EL device.

According to a first aspect of the invention, an organic EL device includes a substrate, an organic planarizing layer disposed on the substrate, a first electrode disposed on the organic planarizing layer, a partition wall disposed on the first electrode and having an opening which defines the first electrode and exposes an upper portion of the first electrode, a functional layer disposed in the opening of the partition wall, and a second electrode disposed so as to cover the functional layer. The partition wall includes at least an inorganic partition wall portion, and the inorganic partition wall portion has an inorganic partition wall portion through-hole which passes through the inorganic partition wall portion and extends to the organic planarizing layer.

In such a structure, in the process of forming the inorganic partition wall portion, even if gases are generated from the organic planarizing layer, the gases pass through the inorganic partition wall portion through-hole and are discharged to outside of the organic planarizing layer. Furthermore, in the manufacturing process after the formation of the inorganic partition wall portion, the substrate is heated and the temperature of the organic planarizing layer is increased, and thereby the discharge of impurities from the inorganic partition wall portion through-hole is accelerated. Thus, the amount of impurities in the organic planarizing layer is decreased and the generation of gases is prevented. Consequently, not only gases can be prevented from being generated from the organic planarizing layer, but also generated gases can be discharged to the outside. Thus, it is possible to prevent the degradation of the display quality of the organic EL device due to the accumulation of gases.

It is preferable that the partition wall include the inorganic partition wall portion that has liquid affinity and an organic partition wall portion that has liquid repellency, the organic partition wall portion being disposed on the inorganic partition wall portion, and an end of the organic partition wall portion be located closer to the inorganic partition wall portion through-hole disposed in the inorganic partition wall portion than an end of the inorganic partition wall portion.

In such a structure, when a liquid-phase material is arranged in the opening of the partition wall, followed by drying, to form the functional layer, the liquid-phase material can be prevented from flowing to the outside by the organic partition wall portion. Furthermore, since a stepped part of the inorganic partition wall portion is exposed at the boundary between the organic partition wall portion and the inorganic partition wall portion in the opening, the wettability in the vicinity of the boundary between the organic partition wall portion and the inorganic partition wall portion in the opening is improved. Consequently, when the volume of the liquid-phase material is decreased due to drying and the liquid surface approaches to the boundary between the organic partition wall portion and the inorganic partition wall portion, the thickness of the liquid-phase material is made uniform by the inorganic partition wall portion, and thus the functional layer can be made flat.

Furthermore, it is preferable that the inorganic partition wall portion include a first inorganic partition wall portion disposed on the organic planarizing layer side and a second inorganic partition wall portion disposed on the organic partition wall portion side, and an end of the second inorganic partition wall portion be located closer to the inorganic partition wall portion through-hole disposed in the inorganic partition wall portion than an end of the first inorganic partition wall portion.

In such a structure, the surface area of the inorganic partition wail portion in the opening further increases, and the wettability of the functional layer with respect to the liquid-phase material further improves. Consequently, the functional layer can be made flatter.

Furthermore, it is preferable that the organic partition wall portion have an organic partition wall portion through-hole which passes through the organic partition wall portion and communicates with the inorganic partition wall portion through-hole or extends to the organic planarizing layer through the inorganic partition wall portion through-hole.

In such a structure, impurities that generate gases in the organic planarizing layer can be discharged to outside of the organic partition wall portion through the organic partition wall portion through-hole.

Furthermore, the inorganic partition wall portion through-hole may include a plurality of holes placed around the opening, or the inorganic partition wall portion through-hole may be in the shape of a groove and continuously disposed around the opening.

In such a structure, the opening area of the inorganic partition wall portion through-hole can be increased, the impurities of the organic planarizing layer can be more effectively discharged, and gases can be prevented from accumulating in the vicinity of the functional layer.

According to a second aspect of the invention, a method of manufacturing an organic EL device having a functional layer interposed between a first electrode and a second electrode disposed on a substrate, includes forming an organic planarizing layer on the substrate; forming the first electrode on the organic planarizing layer; forming an inorganic material layer on the first electrode; forming an inorganic partition wall portion by forming an opening in the inorganic material layer so as to define the first electrode and expose an upper portion of the first electrode, and forming an inorganic partition wall portion through-hole which passes through the inorganic partition wall portion and extends to the organic planarizing layer; forming the functional layer in the opening; and forming the second electrode so as to cover the functional layer.

In such a manufacturing method, in the process of forming the inorganic partition wall portion, impurities, which may generate gases, contained in the organic planarizing layer are discharged through the inorganic partition wall portion through-hole to outside (opposite the substrate) of the organic planarizing layer. Furthermore, in the manufacturing process after the inorganic partition wall portion is formed, the substrate is heated and the temperature of the organic planarizing layer is increased, and thereby the discharge of impurities from the inorganic partition wall portion through-hole is accelerated. Thus, the amount of impurities in the organic planarizing layer is decreased and the generation of gases is prevented. Furthermore, even in the case where gases are generated in the organic planarizing layer, the gases can be discharged to outside of the organic planarizing layer through the inorganic partition wall portion through-hole. Consequently, not only gases can be prevented from being generated from the organic planarizing layer, but also generated gases can be discharged to the outside. Thus, it is possible to prevent the degradation of the display quality of the organic EL device due to the accumulation of gases.

### BRIEF DESCRIPTION OF THE DRAWINGS

The invention will be described with reference to the accompanying drawings, wherein like numbers reference like elements.

FIG. 1 is a cross-sectional view schematically showing a structure of an organic EL device according to a first embodiment of the invention.

FIGS. 2A to 2C are plan views which schematically show arrangement of a hole or holes of the through-hole according the first embodiment of the invention.

FIG. 3 is a schematic diagram showing a wiring structure of the organic EL device according to the first embodiment of the invention,

FIGS. 4A to 4C are cross-sectional views showing steps in a method of manufacturing an organic EL device according to the first embodiment of the invention.

FIGS. 5A to 5C are cross-sectional views showing steps in the method of manufacturing the organic EL device according to the first embodiment of the invention.

FIG. 6A is a cross-sectional view showing a simplified structure of an organic EL device according to the first embodiment of the invention, and FIG. 6B is a cross-sectional view showing a simplified structure of an organic EL device according to a second embodiment of the invention.

FIGS. 7A and 7B are cross-sectional views each showing a simplified structure of an organic EL device according to a third embodiment of the invention.

### DESCRIPTION OF EXEMPLARY EMBODIMENTS

### First Embodiment

A first embodiment of the invention will be described with reference to the drawings. In the drawings, in order to make the individual layers and components recognizable, different scales are used for the individual layers and components.

Organic EL Device

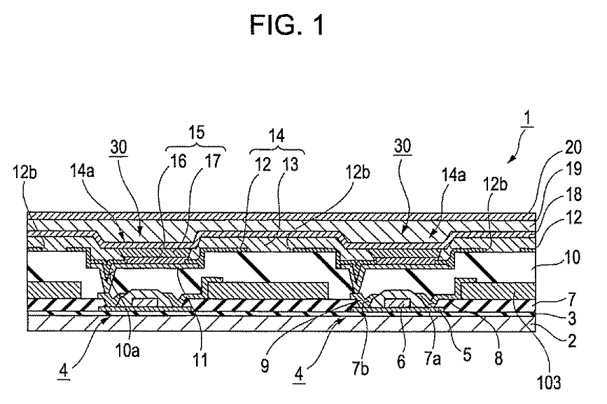

FIG. 1 is a cross-sectional view schematically showing a structure of an organic EL device 1 according to the first embodiment of the invention. Referring to FIG. 1, the organic EL device 1 according to this embodiment is a top-emission-type organic EL device in which light emitted from the functional layers 15 of many organic EL elements 30 disposed on a substrate 2 is extracted from a sealing substrate 20 opposite the substrate 2 provided with the organic EL elements 30.

The substrate 2 is, for example, composed of silicon (Si), and an insulation film 3, for example, composed of silicon oxide (SiO₂) is disposed on the substrate 2. Driving thin-film transistors (TFTs) 4 are disposed on the insulation film 3 so as to correspond to the respective organic EL elements 30. Each driving TFT 4 includes a semiconductor layer 5 disposed on the insulation film 3, and a gate electrode 6 disposed so as to face a channel region of the semiconductor layer 5 with a gate insulation film (not shown) therebetween. An interlayer insulation film 7 is disposed so as to cover the gate insulation film and the gate electrode 6. A source electrode 8 and a drain electrode 9 are disposed on the interlayer insulation film 7 and respectively connected to a source region and a drain region of the semiconductor layer 5 through contact holes 7a and 7b. The source electrode 8 is connected to a power line 103 disposed on the interlayer insulation film 7.

A planarizing layer (organic planarizing layer) 10 is disposed so as to cover the driving TFTs 4 and the power lines 103, thereby planarizing the surface of the substrate 2. The planarizing layer 10 is composed of an organic material having heat resistance and insulating property, such as an acrylic or polyimide material. Each organic EL element 30 has a pixel electrode (first electrode) 11, i.e., an anode, which is disposed on the planarizing layer 10. The pixel electrode 11 is composed of a conductive material having reflectivity, such as aluminum (Al). The pixel electrode 11 is connected to the drain electrode 9 through a contact hole 10a which passes through the planarizing layer 10 and extends to the drain electrode 9. Furthermore, the gate electrode 6 of the driving TFT 4 is electrically connected to a storage capacitor cap that is connected to a switching TFT 112, which will be described below, and stores a pixel signal.

A partition wall 14 is disposed on the pixel electrodes 11, the partition wall 14 including an inorganic partition wall portion 12 and an organic partition wall portion 13 disposed on the inorganic partition wall portion 12. The partition wall 14 has openings 14a, each opening 14a defining the pixel electrode 11 for the corresponding organic EL element 30 and exposing an upper portion (a surface opposite the substrate 2) of the pixel electrode 11. An end (part that defines the opening 14a) of the organic partition wall portion 13 is located closer to a through-hole 12b than an end (part that defines the opening 14a) of the inorganic partition wall portion 12, the through-hole 12b being formed in the partition wall 14 (which will be described below). A part of the inorganic partition wall portion 12 is exposed in the shape of a step in the opening 14a at the boundary between the organic partition wall portion 13 and the inorganic partition wall portion 12 in the opening 14a.

The inorganic partition wall portion 12 is composed of an insulating inorganic material, such as SiO₂. The surface of the inorganic partition wall portion 12 is subjected to liquid affinity-imparting treatment so as to improve wettability and have liquid affinity. The organic partition wall portion 13 is, for example, composed of the same organic material as that of the planarizing layer 10. The surface of the organic partition wall portion 13 is subjected to liquid—repellency imparting treatment so as to have liquid repellency.

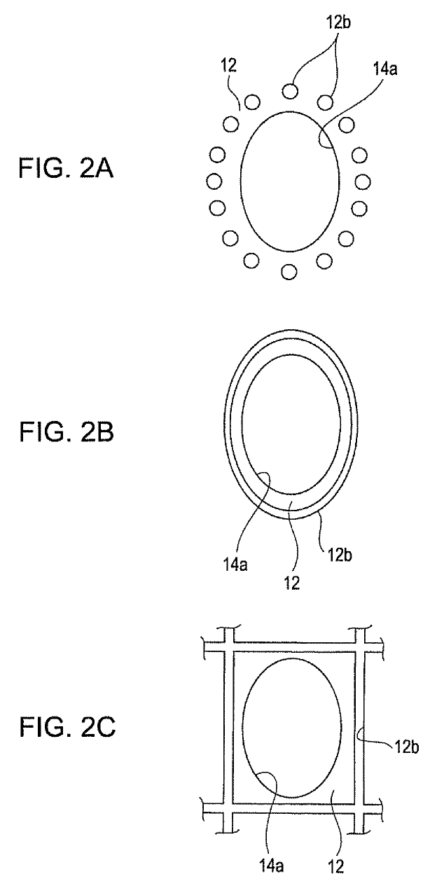

In this embodiment, the inorganic partition wall portion 12 has a through-hole (inorganic partition wall portion through-hole) 12b which passes through the inorganic partition wall portion 12 and extends to the planarizing layer 10. The organic partition wall portion 13 is in contact with the organic planarizing layer 10 via the through-hole 12b. Furthermore, as shown in FIG. 2A, the through-hole 12b may include a plurality of holes placed around the opening 14a in plan view, or as shown in FIG. 2B, the through-hole 12b may be in the shape of a groove and continuously disposed around the opening 14a. Alternatively, as shown in 2C, the through-hole 12b may be in the shape of a groove and continuously disposed like a grid around the opening 14a.

As shown in FIG. 1, a functional layer 15 is disposed in each opening 14a. The functional layer 15 includes a hole injection/transport layer 16 disposed on the pixel electrode 11 side and a luminescent layer 17 deposited thereon. The hole injection/transport layer 16 is formed, for example, by drying a liquid-phase material, such as a dispersion liquid of poly(3,4-ethylenedioxythiophene)-poly(styrenesulfonate) (PEDOT-PSS), i.e., a dispersion liquid prepared by dispersing poly(3,4-ethylenedioxythiophene) in poly(styrenesulfonate) as a dispersion medium, and further dispersing the resulting mixture in water, Furthermore, the luminescent layer 17 is composed of a known luminescent material capable of emitting fluorescent light or phosphorescent light. In particular, when full color display is performed, materials that emit light components corresponding to wavelengths of red, green, and blue are used.

As the material for forming the luminescent layer 17, for example, a (poly)fluorene derivative (PF), a (poly)paraphenylenevinylene derivative (PPV), a polyphenylene derivative (PP), a polyparaphenylene derivative (PPP), polyvinylcarbazole (PVK), a polythiophene derivative, or a polysilane-based material, such as polymethylphenylsilane (PMPS), may be suitably used. Furthermore, these polymer materials may be doped with a high molecular-weight material, such as a perylene-based pigment, a coumarin-based pigment, or a rhodamine-based pigment; or a low molecular-weight material, such as rubrene, perylene, 9,10-diphenylanthracene, tetraphenylbutadiene, Nile red, coumarin 6, or quinacridone. Furthermore, a phosphorescent material, such as Ir(ppy)₃, may be used.

A common electrode (second electrode) 18, which is a cathode of the organic EL element 30, is disposed on the functional layer 15 so as to cover the functional layer 15 and the partition wall 14. The common electrode 18 is composed of a conductive material having light transmittance, such as indium tin oxide (ITO). A sealing substrate 20 composed of a transparent material, such as glass or quartz, is attached onto the common electrode 18 through an adhesive layer 19 having light transmittance.

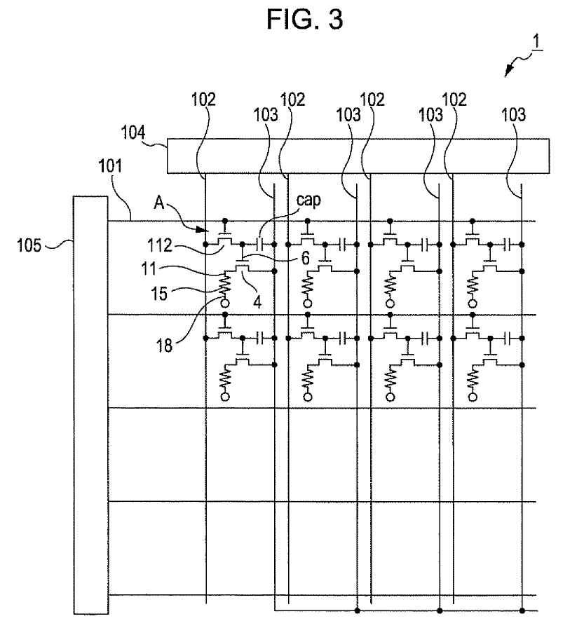

FIG. 3 is a schematic diagram showing a wiring structure of the organic EL device 1 according to this embodiment. As shown in FIG. 3, the organic EL device 1 has a structure in which a plurality of scanning lines 101, a plurality of signal lines 102 extending in a direction orthogonal to the scanning lines 101, and a plurality of power lines 103 extending parallel to the signal lines 102 are arranged. A pixel region A is disposed in the vicinity of each of the intersections of the scanning lines 101 and the signal lines 102.

The signal lines 102 are connected to a data line driving circuit 104 having shift registers, level shifters, video lines, and analog switches. The scanning lines 101 are connected to a scanning line driving circuit 105 having shift registers and level shifters. Each pixel region A includes a switching TFT 112 in which a scanning signal is supplied to the gate electrode through the scanning line 101, a storage capacitor cap which stores a pixel signal supplied from the signal line 102 through the switching TFT 112, a driving TFT 4 in which the pixel signal stored in the storage capacitor cap is supplied to the gate electrode 6, a pixel electrode 11 into which driving current flows from the power line 103 when electrically connected to the power line 103 via the driving TFT 4, and a functional layer 15 interposed between the pixel electrode 11 and the common electrode 18. Note that the pixel electrode 11, the common electrode 18, and the functional layer 15 constitute an organic EL element 30.

In such a structure, when the scanning line 101 is driven and the switching TFT 112 is turned on, the potential of the signal line 102 at that time is stored in the storage capacitor cap, and an on/off state of the driving TFT 4 is determined in accordance with a state of the storage capacitor cap. Current flows into the pixel electrode 11 through the channel of the driving TFT 4, and then flows into the common electrode 18 through the functional layer 15. The functional layer 15 emits light in accordance with the amount of the current flowing therethrough.

Method for Manufacturing Organic EL Device

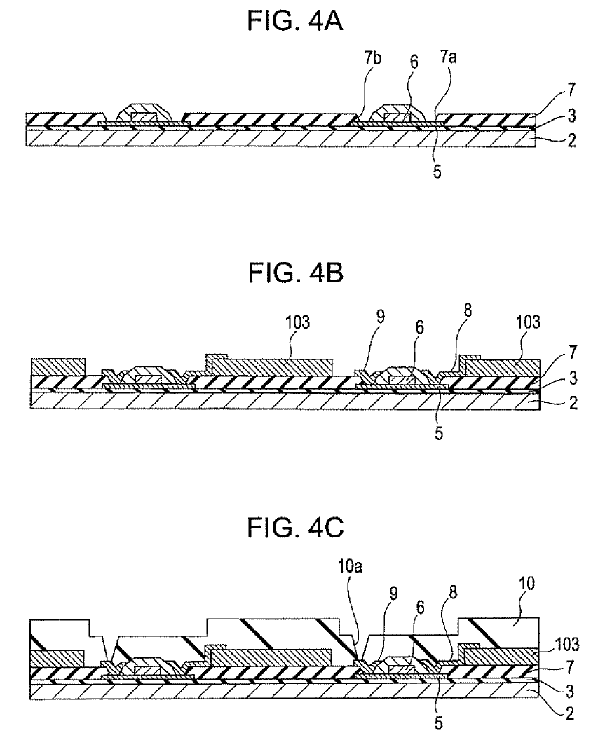

Next, a method of manufacturing the organic EL device 1 will be described, and then operations of this embodiment will be described. First, an insulation film 3 is formed on a substrate 2, and driving TFTs 4, switching TFTs 112, and the lines, circuits, etc. described above are formed on the insulation film 3. As shown in FIG. 4A, a semiconductor layer 5 and a gate insulation film (not shown) which covers the semiconductor layer 5 are formed on the insulation film 3, and each gate electrode 6 is formed thereon. The semiconductor layer 5 is doped with impurities, thereby to form a source region, a drain region, and a channel region for each element. Then, an interlayer insulation film 7 is formed so as to cover them, and contact holes 7a and 7b which pass through the interlayer insulation film 7 and respectively extend to the source region and the drain region of the semiconductor layer 5 are formed by photolithography.

Subsequently, as shown in FIG. 4B, power lines 103 are formed on the interlayer insulation film 7. Then, a source electrode 8 and a drain electrode 9 are formed on the interlayer insulation film 7 for each element. Then, as shown in FIG. 4C, a planarizing layer 10 is formed so as to cover them. Next, a contact hole 10a which passes through the planarizing layer 10 and extends to the drain electrode 9 is formed by photolithography for each element.

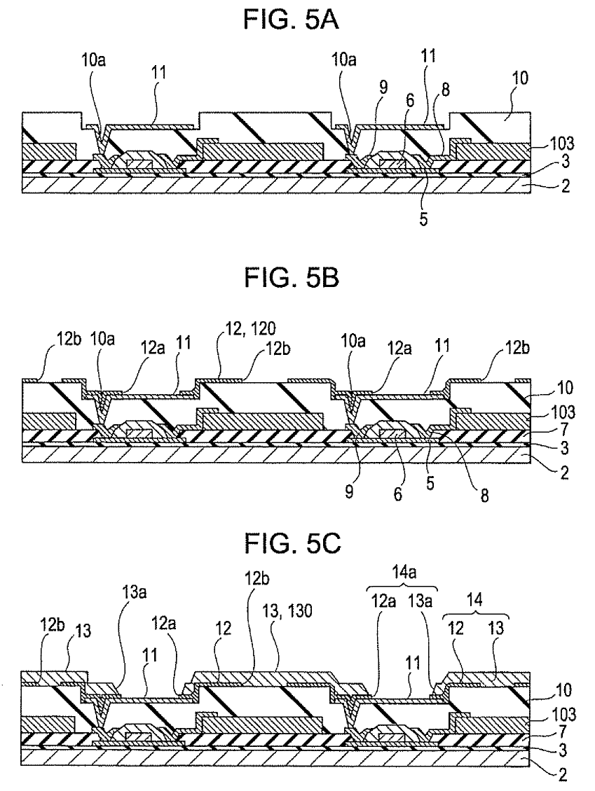

Subsequently, as shown in FIG. 5A, a pixel electrode 11 is formed on the planarizing layer 10, and is connected to the drain electrode 9 via the contact hole 10a for each element. Then, as shown in FIG. 5B, an inorganic material layer 120 is formed in a solid pattern so as to cover the pixel electrodes 11 and the planarizing layer 10. Then, an opening 12a which defines the pixel electrode 11 and exposes an upper portion of the pixel electrode 11 and a through-hole 12b which passes through the inorganic material layer 120 and extends to the planarizing layer 10 are formed in the inorganic material layer 120 by photolithography for each element, thereby to form an inorganic partition wall portion 12. In this stage, impurities which may generate gases remain in the planarizing layer 10. Furthermore, the planarizing layer 10 is exposed to a resist stripper which is used in photolithography.

Subsequently, as shown in FIG. 5C, an organic material layer 130 is formed so as to cover the planarizing layer 10, the pixel electrodes 11, and the inorganic partition wall portion 12, and an opening 13a is formed in the organic material layer 130 by photolithography for each element, thereby to form an organic partition wall portion 13. In this step, the opening 13a of the organic partition wall portion 13 is formed slightly larger than the opening 12a of the inorganic partition wall portion 12. Thus, a partition wall 14 including the inorganic partition wall portion 12 and the organic partition wall portion 13 is formed, the partition wall 14 having openings 14a, each being composed of the opening 12a of the inorganic partition wall portion 12 and the opening 13a of the organic partition wall portion 13.

Subsequently, the surfaces of the pixel electrodes 11 are subjected to washing treatment, and then the surface of the workpiece provided with the pixel electrodes 11, the inorganic partition wall portion 12, and the organic partition wall portion 13 is subjected to oxygen plasma treatment. Thereby, contaminants, such as organic substances, adhering to the surface of the workpiece are removed so that wettability is improved. Specifically, the substrate 2 is heated at a predetermined temperature, for example, at about 70° C. to 80° C., and then plasma treatment (O₂ plasma treatment) is performed at atmospheric pressure, in which oxygen is used as a reaction gas.

Subsequently, by performing liquid -repellency imparting treatment, in particular, the wettability of the upper surface and side surfaces of the organic partition wall portion 13 are decreased. Specifically, by performing plasma treatment (CF₄ plasma treatment) at atmospheric pressure, in which tetrafluoromethane is used as a reaction gas, and by cooling the substrate 2 which has been heated due to the plasma treatment to room temperature, the upper surface and side surfaces of the organic partition wall portion 13 are imparted with liquid repellency so that the wettability is decreased. The exposed surfaces of the pixel electrodes 11 and the inorganic partition wall portion 12 are slightly affected by the CF₄ plasma treatment. However, since ITO which constitutes the pixel electrodes 11 and SiO₂ which is a constituent material for the inorganic partition wall portion 12 have little affinity to fluorine, high wettability is maintained in the surfaces the wettability of which have been improved by the oxygen plasma treatment.

Subsequently, the substrate 2 is subjected to annealing treatment, for example, at about 200° C.

Subsequently, as shown in FIG. 1, a hole injection/transport layer 16 is formed in each opening 14a surrounded by the partition wall 14. In the process of forming the hole injection/transport layer 16, a spin-coating method or a liquid droplet ejecting method may be employed. In this embodiment, from the standpoint that it is necessary to selectively arrange the constituent material for the hole injection/transport layer 16 in the openings 14a, in particular, an ink jet method which is a liquid droplet ejecting method is preferably employed. A dispersion liquid of PEDOT-PSS, which is a material for forming the hole injection/transport layer 16, is placed on the exposed surface of each pixel electrode 11 by the ink jet method, and then, heat treatment (drying/firing treatment) is performed, for example, at 200° C. for about 10 minutes. Thereby, a hole injection/transport layer 16 with a thickness of about 20 to 100 nm is formed. With respect to the formation of the hole injection/transport layer 16, in particular, when the pixel region A is not defined by the inorganic partition wall portion 12 or the organic partition wall portion 13, the spin-coating method may be employed.

Subsequently, a luminescent layer 17 is formed on the hole injection/transport layer 16. In the process of forming the luminescent layer 17, an ink jet method which is a liquid droplet ejecting method is preferably employed as in the formation of the hole injection/transport layer 16. That is, the material for forming the luminescent layer 17 is ejected onto the hole injection/transport layer 16, and then heat treatment is performed in a nitrogen atmosphere at 130° C. for about 30 minutes. Thereby, a luminescent layer 17 with a thickness of about 50 to 200 nm is formed in the opening 14a formed in the partition wall 14. Furthermore, as the solvent used in the material for forming the luminescent layer 17, a solvent that does not redissolve the hole injection/transport layer 16, e.g., xylene, is suitably used. Furthermore, with respect to the formation of the luminescent layer 17, in particular, when the pixel region A is not defined by the inorganic partition wall portion 12 or the organic partition wall portion 13, the spin-coating method may be employed as in the formation of the hole injection/transport layer 16.

Subsequently, a common electrode 18 is formed, using ITO, so as to cover the luminescent layers 17 and the organic partition wall portion 13. In the process of forming the common electrode 18, unlike the formation of the hole injection/transport layer 16 or the luminescent layer 17, the common electrode 18 is formed by vapor deposition, sputtering, or the like over substantially the entire surface of the substrate 2 instead of forming selectively only on the pixel regions A.

Then, an adhesive layer 19 is formed, using an adhesive (adsorbent), on the common electrode 18, and a sealing substrate 20 is bonded to the workpiece by the adhesive layer 19. Thus, sealing is performed.

In the organic EL device 1 according to this embodiment, as described above, the through-holes 12b extending to the planarizing layer 10 are formed in the inorganic partition wall portion 12. Consequently, in the process of forming the inorganic partition wall portion 12, even if gases are generated because the planarizing layer 10 is exposed to a resist stripper and chemical substances contained in the resist stripper act on impurities in the planarizing layer 10, the generated gases are discharged to outside of the planarizing layer 10 via the through-holes 12b. Consequently, it is possible to prevent gases from accumulating in the planarizing layer 10 and between the planarizing layer 10 and the pixel electrodes 11 or the inorganic partition wall portion 12.

Furthermore, when the functional layers 15 are formed by arranging a liquid-phase material in the openings 14a of the partition wall 14, followed by drying, the liquid-phase material is prevented from flowing to outside of the opening 14a by the partition wall 14. Furthermore, since a stepped part of the inorganic partition wall portion 12 is exposed at the boundary between the organic partition wall portion 13 and the inorganic partition wall portion 12 in each opening 14a, the surface area of the inorganic partition wall portion 12 increases in the vicinity of the boundary, resulting in improvement in wettability. Consequently, when the volume of the liquid-phase material is decreased due to drying and the liquid surface approaches to the boundary between the organic partition wall portion 13 and the inorganic partition wall portion 12, the thickness of the liquid-phase material is made uniform due to the wettability of the inorganic partition wall portion 12, and thus the functional layer 15 can be made flat.

Furthermore, after the inorganic partition wall portion 12 having the through-holes 12b is formed, by heating the substrate 2 in plasma treatment, annealing treatment, etc., the temperature of the planarizing layer 10 is increased, and the discharge of impurities from the through-holes 12b is accelerated. Thus, the amount of impurities in the planarizing layer 10 is decreased. Consequently, after the organic EL elements 30 are sealed by the sealing substrate 20, gases are prevented from being generated from the planarizing layer 10, and the accumulation of gases inside the organic EL device 1 can be prevented.

Furthermore, the through-hole 12b includes a plurality of holes placed around the opening 14a or the through-hole 12b is in the shape of a groove and continuously disposed around the opening 14a. Consequently, the opening area of the through-hole 12b can be increased, impurities and gases in the planarizing layer 10 can be more effectively discharged, and gases can be prevented from accumulating in the vicinity of the functional layer 15.

As described above, in the organic EL device 1 and the method of manufacturing the organic EL device 1 according to this embodiment, not only gases can be prevented from being generated from the planarizing layer 10, but also gases generated from the planarizing layer 10 in the manufacturing process can be discharged to the outside. Thus, it is possible to prevent the degradation of the display quality of the organic EL device 1 due to the accumulation of gases.

### Second Embodiment

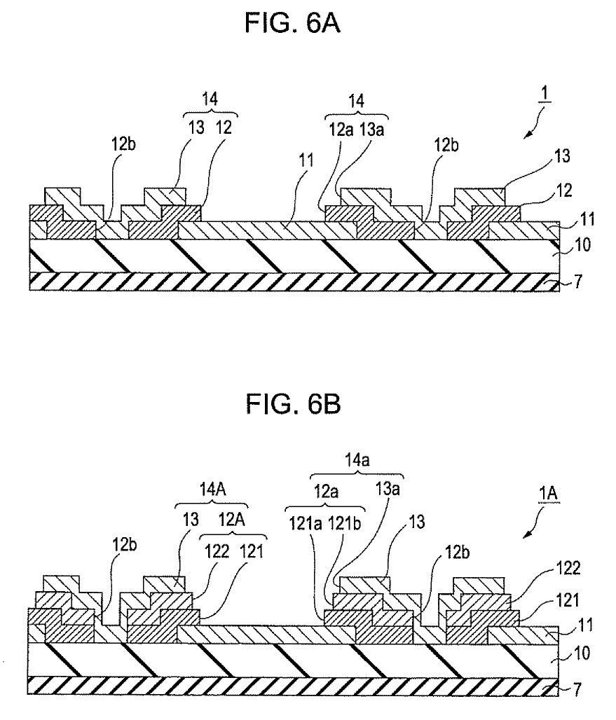

A second embodiment of the invention will be described with reference to FIGS. 1 to 5C and newly to FIGS. 6A and 6B. As shown in FIG. 6B, an organic EL device 1A according to the second embodiment differs from the organic EL device 1 according to the first embodiment shown in FIG. 6A in that, instead of the inorganic partition wall portion 12, an inorganic partition wall portion 12A having a two-layer structure including a first inorganic partition wall portion 121 and a second inorganic partition wall portion 122 is used. Otherwise, the second embodiment is the same as the first embodiment. Consequently, the same components or parts as those of the first embodiment are designated by the same reference numerals, and description thereof is omitted.

FIG. 6A is a cross-sectional view showing a simplified structure of the organic EL device 1 shown in FIG. 1, and FIG. 6B is a cross-sectional view showing a simplified structure of the organic EL device 1A according to the second embodiment. In FIGS. 6A and 6B, the substrate 2, the driving TFTs 4, the power lines 103, the functional layers 15, the common electrode 18, the adhesive layer 19, the sealing substrate 20, etc. are not shown. FIGS. 6A and 6B center on the partition wall 14 and the planarizing layer 10.

As shown in FIG. 6B, in the organic EL device 1A according to this embodiment, the inorganic partition wall portion 12A includes the first inorganic partition wall portion 121 disposed on the planarizing layer 10 side and the second inorganic partition wall portion 122 disposed on the organic partition wall portion 13 side. The first inorganic partition wall portion 121 is, for example, composed of SiO₂ or the like as in the first embodiment, and the second inorganic partition wall portion 122 is, for example, composed of silicon nitride (SiN) or the like. An end (part that defines an opening 121b) of the second inorganic partition wall portion 122 is located closer to a through-hole 12b formed in a partition wall 14A than an end (part that defines an opening 121a) of the first inorganic partition wall portion 121. A part of the first inorganic partition wall portion 121 is exposed in the shape of a step in the opening 14a.

In this embodiment, as shown in FIG. 6B, the inorganic partition wall portion 12A has a two-layer structure including the first inorganic partition wall portion 121 and the second inorganic partition wall portion 122. The end of the second inorganic partition wall portion 122 is located closer to the through-hole 12b formed in the partition wall 14A than the end of the first inorganic partition wall portion 121. A part of the first inorganic partition wall portion 121 is exposed in the shape of a step in the opening 14a. Consequently, the surface area of the inorganic partition wall portion 12A in the opening 14a increases. Thus, when the functional layer 15 is formed using a liquid-phase material as in the first embodiment, the wettability of the functional layer 15 with respect to the liquid-phase material further improves Consequently, the functional layer 15 can be made flatter.

Furthermore, in the second embodiment, since the through-holes 12b are formed in the inorganic partition wall portion 12A as in the first embodiment, the same advantages as those of the first embodiment can be obtained.

### Third Embodiment

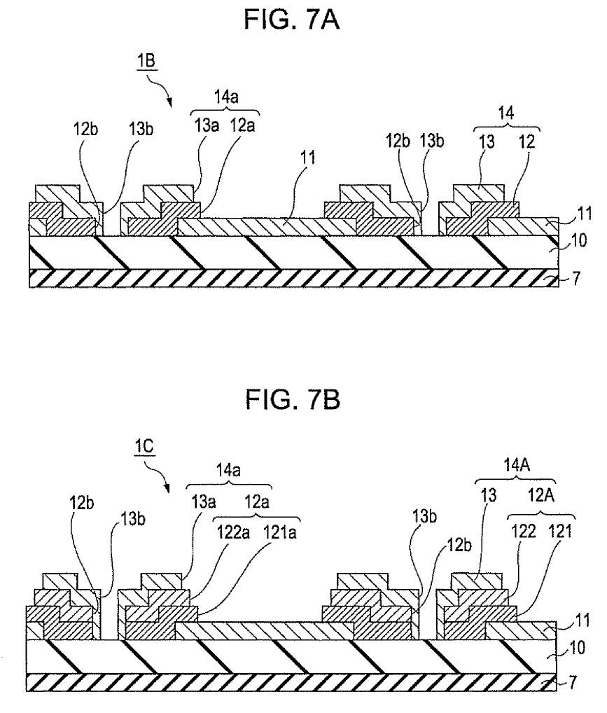

A third embodiment of the invention will be described with reference to FIGS. 1 to 6B and newly to FIGS. 7A and 7B. Organic EL devices according to this embodiment differ from the organic EL device 1 or 1A according to the first or second embodiment in that through-holes 13b are formed in the organic partition wall portion 13. Otherwise, the third embodiment is the same as the first or second embodiment. Consequently, the same components or parts as those of the first or second embodiment are designated by the same reference numerals, and description thereof is omitted.

FIGS. 7A and 7B are cross-sectional views respectively showing simplified structures of organic EL devices 1B ad 1C according to this embodiment as in FIGS. 6A and 6B. In each of the organic EL devices 1B and 1C according to this embodiment, as shown in FIGS. 7A and 7B, the organic partition wall portion 13 has through-holes (organic partition wall portion through-holes) 13b, each passing through the organic partition wall portion 13 and extends to the planarizing layer 10 through a through-hole 12b formed in the inorganic partition wall portion 12 or 12A. The through-holes 13b are, for example, formed by photolithography, etc., before annealing is performed.

In this embodiment, even after the organic partition wall portion 13 is formed in the manufacturing process, impurities that generate gases in the planarizing layer 10 can be discharged to outside of the organic partition wall portion 13 through the through-holes 13b. That is, impurities in the planarizing layer 10 and gases generated in the planarizing layer 10 can be directly discharged to outside of the planarizing layer 10 without being passed through the organic partition wall portion 13.

In this embodiment, in addition to the fact that the same advantages as those of the organic EL devices 1 and 1A according to the first and second embodiments can be obtained, generation of gases can be prevented more reliably, gases generated from the planarizing layer 10 in the manufacturing process can be more reliably discharged to the outside, and it is possible to more reliably prevent the degradation of the display quality of the organic EL devices 1B and 1C due to the accumulation of gases.

It is to be understood that the invention is not limited to the embodiments described above, and various modifications can be made as long as they do not deviate from the scope of the invention. For example, as the material having light transmittance for the common electrode, Pt, Ir, Ni, or Pd may be used besides ITO. The film thickness is preferably about 75 nm from the standpoint of ensuring transparency, and more preferably, the film thickness is smaller than this value.

Although top-emission-type organic EL devices are described in the embodiments, it is of course possible to apply the invention to bottom-emission-type organic EL devices in which light is extracted from a side opposite the side in the embodiments described above. Furthermore, even when the invention is implemented using an element substrate for a passive matrix device, instead of an active matrix device using TFTs or the like, and passive matrix driving is performed, the same advantages can be obtained at low cost.

Furthermore, in the second embodiment, through-holes and openings can be formed in the first inorganic partition wall portion and the second inorganic partition wall portion at one time by photolithography. Thereby, the manufacturing process can be simplified, and productivity can be improved

Furthermore, in the third embodiment, each through-hole (organic partition wall portion through-hole) in the organic partition wall portion and the corresponding through-hole (inorganic partition wall portion through-hole) in the inorganic partition wall portion may be formed with substantially the same diameter such that both through-holes communicate with each other.

The entire disclosure of Japanese Patent Application No. 2008-029339, filed Feb. 8, 2008 is expressly incorporated by reference herein.

What is claimed is:

1. An organic EL device comprising:
a substrate;
an organic planarizing layer disposed on the substrate;
a first electrode disposed on the organic planarizing layer;
a partition wall disposed on the first electrode and having an opening which defines the first electrode and exposes an upper portion of the first electrode;
a functional layer disposed in the opening of the partition wall; and
a second electrode disposed so as to cover the functional layer,
wherein the partition wall includes at least an inorganic partition wall portion, and the inorganic partition wall portion has an inorganic partition wall portion through-hole which passes through the inorganic partition wall portion and extends to the organic planarizing layer.

2. The organic EL device according to claim 1, wherein the partition wall includes the inorganic partition wall portion that has liquid affinity and an organic partition wall portion that has liquid repellency, the organic partition wall portion being disposed on the inorganic partition wall portion, and an end of the organic partition wall portion is located closer to the inorganic partition wall portion through-hole disposed in the inorganic partition wall portion than an end of the inorganic partition wall portion.

3. The organic EL device according to claim 2, wherein the inorganic partition wall portion includes a first inorganic partition wall portion disposed on the organic planarizing layer side and a second inorganic partition wall portion disposed on the organic partition wall portion side, and an end of the second inorganic partition wall portion is located closer to the inorganic partition wall portion through-hole disposed in the inorganic partition wall portion than an end of the first inorganic partition wall portion.

4. The organic EL device according to claim 2, wherein the organic partition wall portion has an organic partition wall portion through-hole which passes through the organic partition wall portion and communicates with the inorganic partition wall portion through-hole or extends to the organic planarizing layer through the inorganic partition wall portion through-hole.

5. The organic EL device according to claim 1, wherein the inorganic partition wall portion through-hole includes a plurality of holes placed around the opening, or the inorganic partition wall portion through-hole is in the shape of a groove and continuously disposed around the opening.

6. A method of manufacturing an organic EL device having a functional layer interposed between a first electrode and a second electrode disposed on a substrate, the method comprising:
forming an organic planarizing layer on the substrate;
forming the first electrode on the organic planarizing layer;
forming an inorganic material layer on the first electrode;
forming an inorganic partition wall portion by forming an opening in the inorganic material layer so as to define the first electrode and expose an upper portion of the first electrode, and forming an inorganic partition wall portion through-hole which passes through the inorganic partition wall portion and extends to the organic planarizing layer;
forming the functional layer in the opening; and
forming the second electrode so as to cover the functional layer.
